(19) United States
(12) Patent Application Publication
(10) Pub. No.: US 2012/0315494 A1
(43) Pub. Date: Dec. 13, 2012

(54) Polyamic Acid Resin Composition, Method for Preparing the Same and Polyimide Metal Clad Laminate Using the Same

(75) Inventors: Weon Jung Choi, Seo-gu (KR); Dae Nyoun Kim, Yuseong-gu (KR); Seung Hoon Jung, Yeongdeungpo-gu (KR); Byoung Wook Jo, Seo-gu (KR); Cheol Ho Kim, Yuseong-gu (KR)

(73) Assignee: SK INNOVATION CO., LTD., Seoul (KR)

(21) Appl. No.: 13/518,119

(22) PCT Filed: Dec. 21, 2010
(86) PCT No.: PCT/KR10/09156

§ 371 Date: Jul. 19, 2012

(30) Foreign Application Priority Data
Dec. 22, 2009 (KR) 10-2009-0128726

(51) Int. Cl. C09D 167/00; B32B 15/088; B32B 15/04

(52) U.S. Cl. 428/458; 523/400; 428/457

(57) ABSTRACT

There is provided a polyamic acid resin composition, a method for preparing the same and a polyimide metal clad laminate using the same, in which the polyamic acid resin composition includes an epoxy compound represented by Chemical Formula 1 is defined in specification.

### TECHNICAL FIELD

The present invention relates to a polyamic acid resin composition, a method for preparing the same and a polyimide metal clad laminate using the same. More particularly, the present invention relates to a polyamic acid resin composition and a method for preparing the same, in which the polyamic acid resin composition includes an epoxy compound having a specific structure, thereby preventing a blistering.

### BACKGROUND ART

A flexible metal clad laminate (hereinafter, called as ‘metal clad laminate’ used for preparing a flexible printed circuit board is a laminate of an insulation resin and a conductive metal clad, and is possible to be subjected to a micro circuit processing and to bend in a narrow area. As a result, an application of the metal clad laminate is growing in the field of a notebook computer, a personal digital assistant, a small video camera, a storage disk, and the like following the trend that electronic devices are getting smaller and lighter.

The metal clad laminate includes one side metal clad laminate that is composed of a metal clad layer and a polyimide layer, and both sides metal clad laminate that is composed of a polyimide layer between two metal clad layers. A The method for preparing the metal clad laminate is to may be classified into Roll to Roll process and a batch process according to a the curing way. The batch process needs before and after processes for prevent an adhesion that can be easily occurred between the metal clad and polyimide before and after a batch curing, and a unit length of roll should be shortened, so that there is a problem with a decreasing productivity.

The Roll to Roll process is a method comprising coating a polyamic acid resin that is a polyimide's precursor on the metal clad, drying, and then curing, in which heat is applied before winding while unwinding. There are advantages of Roll to Roll process such as the decrease in time and cost and the conquest of the decreasing productivity that are problems of the conventional batch process. However, the Roll to Roll process should process conduct a curing within a short space of time, so that many defective phenomena such as a blistering, a sharp expansion, a wrinkling according due to a contraction and the like can be easily occurred by applying a rapid heat during the curing.

Generally, the metal clad laminate is composed of more than one polyimide layer. But the some metal clad laminates has one polyimide layer in order to increase productivity. However, the metal clad laminate having more than two polyimide layers is to may be used to prevent be prevented of a warpage and curl between the metal clad and laminate, and has to improve physical properties, such as an adhesive property, a mechanical property, an electrical property, and the like. However, if the adhesion on a surface between polyimide layers is not sufficient, a blistering is generated in the metal clad laminate having more than two polyimide layers become have a blistering due to a delamination, and there is a rapid volatilization of water and solvent during Roll to Roll curing as compared to the metal clad laminate having one polyimide layer. Thus, the production speed should be decreased in order to solve the above problems.

### DISCLOSURE OF INVENTION

### Technical Problem

An aspect of the present invention provides a metal clad laminate, in which there is no blistering on a polyimide layer when preparing a polyimide metal clad laminate. More specifically, an aspect of the present invention provides a method for preparing a polyimide metal clad laminate by coating more than two layers of polyamic acid resin composition on the metal clad and Roll to Roll curing, in which a blistering among surfaces between polyimide layers is prevented by preparing a metal clad laminate through coating more than one layer of polyamic acid resin composition added with an epoxy compound having a specific structure on the top of the metal clad.

### Solution to Problem

A polyamic acid resin composition for solving the above technical task includes more than one epoxy compound selected from the group consisting of the following Chemical Formula 1:

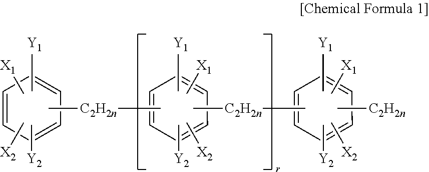

[where,

X₁ and X₂ may be independently substituted or unsubstituted with —CₘH₂ₘ—CH₃, respectively,

more than one of Y₁ or Y₂ is selected from

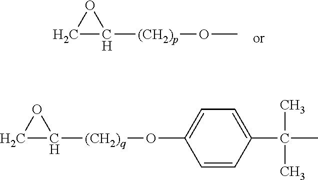

(p and q are integers from 1 to 5),

m and n are integers from 1 to 5, and

r is a natural number from 1 to 10]

1 to 10 wt % of the epoxy compound among the total composition is preferably used.

A method for preparing the polyamic acid resin composition includes adding an aromatic diamine, more than one epoxy compound selected from the group consisting of the above Chemical Formula 1, and an aromatic dianhydride to a solvent, and then mixing to be polymerized.

The present invention includes the polyimide metal clad laminate containing more than one polyimide layer, in which the above mentioned polyamic acid resin composition is applied on one side of metal clad.

The polyimide metal clad laminate may further includes an adhesive layer between the metal clad and the polyimide layer. The adhesive layer that is composed of a polyamic acid resin composition, in which bismaleimide, imidazole, and imidazole triazie compound are added.

Hereinafter, the present invention will be descried in more detail.

The polyamic acid resin composition according to the present invention includes more than one epoxy compound, which has a specific structure, selected from the group consisting of the following Chemical Formula 1. More specifically, the polyamic acid resin composition according to the present invention includes the an aromatic diamine and, an aromatic dianhydride, a solvent, and the epoxy compound represented by the following Chemical Formula 1:

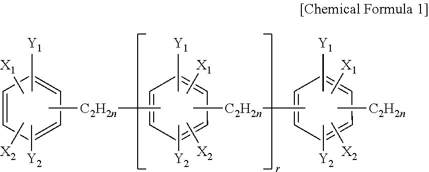

[where,

X₁ and X₂ may be independently substituted or unsubstituted with —CₘHₘ—CH₃, respectively,

more than one of Y₁ or Y₂ is selected from

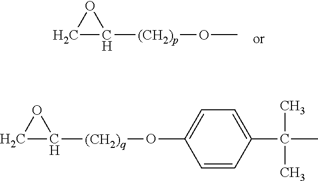

(p and q are integers from 1 to 5),

m and n are integers from 1 to 5, and

r is a natural number from 1 to 10]

The present invention may form multi-layers polyimide layer by laminating more than two layers of polyamic acid composition, in which the epoxy compound having the above structure is applied on the top of the metal clad. At this point, the blistering between the polyimide layers for composed of the polyamic acid resin composition can be prevented.

1 to 10 wt % of the epoxy compound among the total composition is preferably used. 2 to 5 wt % of the epoxy compound is more preferably used. The epoxy group within the above content range can improve the adhesion of surface between polyimide layers that are composed of multi-layers, thereby suppressing the blistering. When the content of the epoxy compound is less than 1 wt %, the blistering is occurred; when the content of the epoxy compound is excess 10 wt %, a thermal resistance is deteriorated.

Preferably, the epoxy compound uses comprises the compounds of the following Chemical Formula 2 to 4:

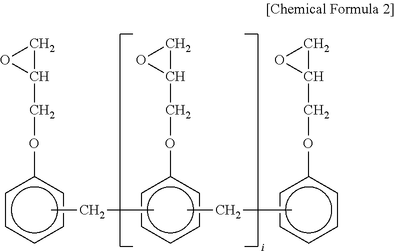

(where,

i is a natural number from 0 to 10)

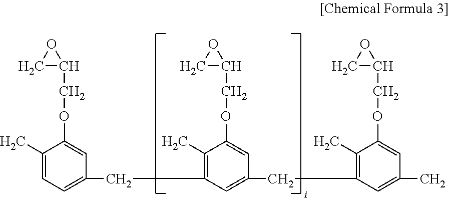

(where,

j is a natural number from 0 to 10)

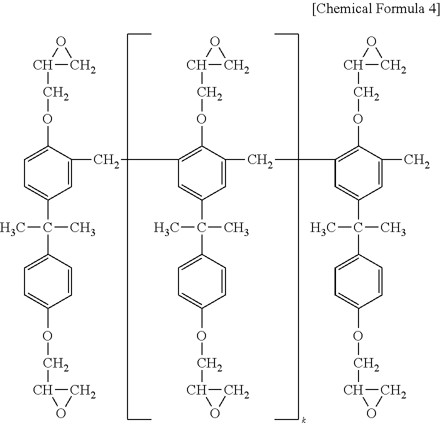

(where,

k is a natural number from 0 to 10)

The solvent according to the present invention may include N-methylpyrrolidone (NMP), dimethylformamide (DMF), N,N-dimethylacetamide (DMAc), N,N-dimethylacetamide, dimethylsulfoxide (DMSO), diethylformamide, hexamethylsulfonamide, sulfoxide, dimethyl sulfate, sulfolane, bytylrolactone, cresol, phenol, phenol halides, cyclohexane, dioxane, tetrahydrofuran, diglyme, triglyme, and the like. Each solvent or combination of more than two solvents can be used. DMAc, NMP and DMF are preferably used among them. The amount of the solvent is preferably a sufficient amount for evenly dissolving each component, and 10 to 20 wt % of solid contents as compared to the solvent is preferred.

The aromatic diamine may include paraphenylenediamine, metaphenylenediamine, 2,4-diaminotoluene, 1,3-bis-(3-aminophenoxy)benzene, 4,4′-diamino-2′-phenoxybenzanilide, 3,4′-diaminodiphenylether, 4,4′-diamino-2,2′-dimethylbiphenyl, 4,4′-diaminodiphenylether, 2,2′-bis[4-(4-aminophenoxy)phenyl]propane, 4,4′-bis(3-aminophenoxy)biphenol, 4,4′-diaminophenylpropane, 3,3′-diaminobenzophenone, 4,4′-diaminodiphenylsulfide, and the like. Each diamine compound or combination of more than two diamine compounds may be used. 40 to 45 wt % of the aromatic diamine compound among the total composition is preferably used.

The aromatic dianhydride may preferably include 3,3′,4,4′-biphenyl dianhydride (BPDA), pyromellitic dianhydride, benzophenone dianhydride, oxydiphenyl dianhydride, and the like. 40 to 45 wt % of the aromatic dianhydride among the total composition is preferably used.

The polyamic acid resin composition is prepared by perfectly dissolving the aromatic diamine in the solvent, adding the epoxy compound, and mixing with the aromatic dianhydride to be polymerized.

The present invention includes the polyimide metal clad laminate containing more than one polyimide layer, in which the above mentioned polyamic acid resin composition is applied on one side of the metal clad.

A method for preparing the polyimide metal clad laminate includes applying and coating the polyamic acid resin composition on one side of the metal clad, drying and then curing. The drying is carried out at 100° C. to 200° C. for 30 seconds to 30 minutes, and the curing is processed at 350° C. to 450° C. for 2 minutes to 60 minutes. Preferably, the drying is carried out at 130° C. to 180° C. for 1 to 10 minutes, and the curing is processed at 370° C. to 420° C. for 5 minutes to 20 minutes. One side metal clad laminate prepared from by the above process may be subjected to a surface modification through a plasma treatment method, corona treatment method, and the like.

One side metal clad laminate prepared from by the above method can be used to form a both sides metal clad laminate by lamination. At this point, the temperature of lamination is 300° C. to 400° C., and preferably 350° C. to 390° C., but not limited thereto. The thickness range of the polyimide layer is preferably 3 μm to 100 μm, and more preferably 10 μm to 50 μm.

The polyimide metal clad laminate may further includes an adhesive layer between the metal clad and the polyimide layer. The adhesive layer that is composed of polyamic acid resin composition, in which bismaleimide, imidazole, and imidazole triazine compound are added.

### Advantageous Effects of Invention

The present invention can improve an the adhesive one of the surface between polyimide layers by adding the epoxy compound on more than one polyimide layer thereby solving the blistering that is occurred on the surface between polyimide layers of metal clad laminate laminated with more than two polyimide layers on the top of metal clad. As a result, the blistering that is occurred on the surface is greatly suppressed, and then eventually the production speed of the metal clad laminate laminated with more than two layers can be improved.

### MODE FOR THE INVENTION

### Example

Hereinafter, the embodiment is only for describing the present invention in more specific and the present invention is not limited to the following embodiments.

The polyamic acid resin composition is composed of 4,4′-diaminodiphenyl ether (ODA), paraphenylenediamine (PDA), 3,3,4,4-biphenyltetracarboxylic acid dianhydride (BPDA), and N,N-dimethylacetamide (DMAc), and uses YDCN500-90P (Kukdo Chemical), YDPN-638 (Kukdo Chemical), and N865 (Kukdo Chemical) as the epoxy compound. A component ratio of the polyamic acid resin composition was shown in the following Table 1.

TABLE 1
A Component Ratio of Polyamic Acid Resin Composition

| | | Aromatic | | | |
|---|---|---|---|---|---|
| | Aromatic | Diamine | | | |
| | Dianhydride | | ODA | Epoxy Compound | |
| | BPDA content | PDA content | content | | Content |
| | (wt %) | (wt %) | (wt %) | Product Name | (wt %) |
| A | 50.25 | 47.26 | 2.49 | | |
| B | 49.03 | 46.12 | 2.43 | YDCN500-90P | 2.43 |
| C | 49.03 | 46.12 | 2.43 | YDPN-638 | 2.43 |
| D | 49.03 | 46.12 | 2.43 | N865 | 2.43 |
| E | 50.25 | 24.88 | 24.88 | | |
| F | 49.51 | 24.51 | 24.51 | YDCN500-90P | 1.47 |
| G | 49.03 | 24.27 | 24.27 | YDCN500-90P | 2.43 |

The reaction for compositions A to G was processed under nitrogen atmosphere by being mole ratio of aromatic diamine to anhydride of 1.01:1, in which 13 wt % of the solid contents is in the N,N-dimethylacetamide (DMAc), and adding the epoxy compound.

### Example 1

Composition E disclosed in the above Table 1 was coated on a 12 μm electro deposited (ED) (hereinafter called as ‘ED’ clad to form a first layer. The thickness of polyimide was to be 5 μm. The first layer formed by coating the above coating process was dried at 140° C. for 10 minutes.

Next, Composition B was coated on the first layer to be a second layer having 10, 20, 30, and 40 μm of polyimide thickness, and then dried at 140° C. for 10 minutes. Since then it was cured using Roll to Roll curing machine from room temperature to 380 in a velocityrate of increasing temperature of 40 per minute to prepare a polyimide flexible metal clad laminate. Then the following physical property was measured and the results were shown in Table 2.

Measurement of Physical Property

The number of blistering: The average of 5 times, of which the number of blistering were occurred in 10 cm×10 cm, were recorded. When no blistering was occurred, ‘NO’ was recorded; when the measurement was not impossible since the blistering was occurred on the whole surface, ‘Completely Delamitaion Delamination’ was recorded.

### Example 2

The polyimide ductility metal clad laminate was prepared using the same method used in Example 1, except using Composition C instead of Composition B disclosed in the above Table 1. Then the following physical property was measured and the results were shown in Table 2.

### Example 3

The polyimide ductility metal clad laminate was prepared using the same method used in Example 1, except using Composition D instead of Composition B disclosed in the above Table 1. Then the following physical property was measured and the results were shown in Table 2.

### Example 4

Composition F disclosed in the above Table 1 was coated on a 12 μm ED clad to form a first layer. The thickness of polyimide was to be 5 μm. The first layer formed by coating the above coating process was dried at 140° C. for 10 minutes.

Next, Composition A was coated on the first layer to be a second layer having 10, 20, 30, and 40 μm of polyimide thickness, and then dried at 140° C. for 10 minutes. Since then it was cured using Roll to Roll curing machine from room temperature to 380° C. in a rate velocity of increasing temperature of 2° C. per minute to prepare a polyimide flexible metal clad laminate. Then the following physical property was measured and the results were shown in Table 2.

### Example 5

The polyimide ductility metal clad laminate was prepared using the same method used in Example 4, except using Composition G instead of Composition F disclosed in the above Table 1. Then the following physical property was measured and the results were shown in Table 2.

### Comparative Example 1

The polyimide ductility metal clad laminate was prepared using the same method used in Example 1, except using Composition A instead of Composition B disclosed in the above Table 1. Then the following physical property was measured and the results were shown in Table 2.

TABLE 2
Results of Physical Property

| | Second | The Number of Blistering for various | | | |
|---|---|---|---|---|---|
| | Layer/ | polyimide (PI) thicknesses (μm) of Second | | | |
| | First | layer (Number) | | | |
| | Layer | 10 μm | 20 μm | 30 μm | 40 μm |
| Comp. | A/E | 6 | 18 | Completely | Completely |
| Example 1 | | | | Delamination | Delamination |
| Example 1 | B/E | No | No | 5 | 9 |
| Example 2 | C/E | No | No | 4 | 9 |
| Example 3 | D/E | No | No | 5 | 12 |
| Example 4 | A/F | No | No | 8 | 24 |
| Example 5 | A/G | No | No | 5 | 11 |

As shown in the above Table 2, the polyimide metal clad laminates according to the present invention in Example 1 to Example 5 have no blistering in their second polyimide layers having thickness of 10 μm and 20 μm. Not like Comparative Example 1, it can be found that the polyimide metal clad laminates according to the present invention was added with the epoxy compound, and then have significant effects for removing the blistering. In addition, in the case of the second polyimide layer having thickness of 30 μm and 40 μm, it can be found that the polyimide metal clad laminates according to Example 1 to Example 5 have a strength of delamination such that 4 to 24 numbers of blistering were occurred, not like Comparative Example 1 that shown Completely Delamination.

### INDUSTRIAL APPLICABILITY

The present invention can greatly suppress the blistering that is occurred on the surface and then eventually the production speed of the metal clad laminate laminated with more than two layers can be improved.

1. A polyamic acid resin composition comprising more than one epoxy compound selected from the group consisting of the following Chemical Formula 1: 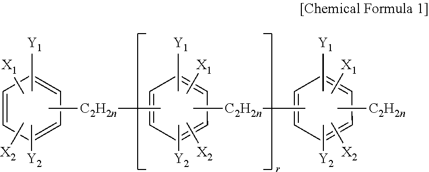
[where,
X₁ and X₂ is independently substituted or unsubstituted with —CₘH₂ₘ—CH₃, respectively, more than one of Y₁ or Y₂ is selected from 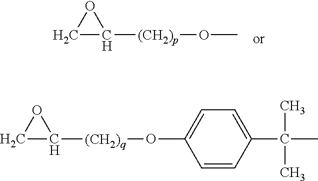
(p and q are integers from 1 to 5),
m and n are integers from 1 to 5, and
r is an actual number from 1 to 10]

2. The polyamic acid resin composition of claim 1, wherein 1 to 10 wt % of the epoxy compound among the total composition is used.

3. A method for preparing a polyamic acid resin composition comprising: adding an aromatic diamine, more than one epoxy compound selected from the group consisting of the following Chemical Formula 1, and an aromatic dianhydride to solvent; and then mixing to be polymerized: 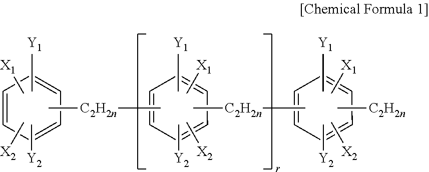
[where,
X₁ and X₂ is independently substituted or unsubstituted with —CₘHₘ—CH₃, respectively, more than one of Y₁ or Y₂ is selected from 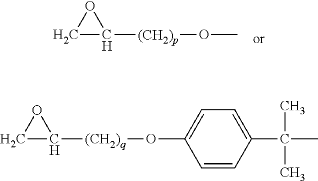
(p and q are integers from 1 to 5),
m and n are integers from 1 to 5, and
r is an actual number from 1 to 10]

4. The method for preparing the polyamic acid resin composition of claim 3, wherein 1 to 10 wt % of the epoxy compound among the total composition is used.

5. A polyimide metal clad laminate comprising more than one polyimide layer, in which a polyamic acid resin composition selected from claim 1 is applied on one side of a metal clad.

6. The polyimide metal clad laminate of claim 5, further comprising an adhesive layer between the metal clad and the polyimide layer, wherein the adhesive layer is composed of a polyamic acid resin composition, in which bismaleimide, imidaole, and imidazole triazine compound are added.

7. A polyimide metal clad laminate comprising more than one polyimide layer, in which a polyamic acid resin composition selected from claim 2 is applied on one side of a metal clad.

8. The polyimide metal clad laminate of claim 7, further comprising an adhesive layer between the metal clad and the polyimide layer, wherein the adhesive layer is composed of a polyamic acid resin composition, in which bismaleimide, imidaole, and imidazole triazine compound are added.
